(19) United States
(12) Patent Application Publication
(10) Pub. No.: US 2013/0052618 A1
(43) Pub. Date: Feb. 28, 2013

(54) Computerized focused, individualized bar exam preparation

(71) Applicants: Harvey R. Clapp, III, Baltimore, MD (US); Donald Allen Gillenwater, Cockeysville, MD (US)

(72) Inventors: Harvey R. Clapp, III, Baltimore, MD (US); Donald Allen Gillenwater, Cockeysville, MD (US)

(73) Assignee: Modern Bar Review Course, Inc.

(21) Appl. No.: 13/506,978

(22) Filed: May 29, 2012

Related U.S. Application Data
(60) Provisional application No. 61/529,654, filed on Aug. 31, 2011.

(51) Int. Cl. G09B 19/00

(52) U.S. Cl. 434/219

(57) ABSTRACT

Interactive, web based method for preparing a candidate, generally a law school graduate, to pass the knowledge-based exams, commonly known as “the bar exam”, required to obtain a license to practice law within a state. Unlike other bar preparation products, this method first assesses what the candidate knows and then directs the candidate's study towards those areas that are likely to provide the “most bang for the buck.” Information is presented in “bite-sized” portions with prompt feedback through testing to ascertain comprehension and retention of this information. Flexible scheduling permits a candidate to select an individualized start date and pace that is adjustable based on the time remaining before the exam and material to be covered.

### NON-PROVISIONAL PATENT APPLICATION

This application is entitled to, and claims the benefit of, priority from U.S. Provisional Application Ser. No. 61/529,654, filed May 26, 2011, which is incorporated herein by reference.

### FIELD AND BACKGROUND OF THE INVENTION

1. Field of the Invention

The invention relates in general to education systems, and more particularly to one which includes a computerized component and is specifically directed to preparation for a bar exam.

2. Background Information

The invention described and claimed herein comprises a novel process, machine and system useful for assisting a user to prepare for a bar exam.

The American legal profession is unique in requiring, as a condition for licensing, successful completion of a single written, time-limited examination, taken following completion of a multi-year educational program at a law school. Each state establishes its own licensing requirements and drafts its own bar examination, although most states include as a component of the examination a standardized national multiple choice examination known at the multistate bar exam. The majority of candidates for licensure engage in some form of preparatory review for the licensing examination, among which a “bar review” course is the most common type. The objective of a bar review course is to provide a candidate with sufficient skills and information to pass this specific exam in the specific state in which the candidate seeks licensure.

A candidate differs from a law student. A candidate will have had prior exposure to some or all of the material covered by a bar examination. This is in contrast to students entering law school who by and large are coming to the subject for the first time. Law schools do not take into account a candidate's familiarity with a subject area and currently bar review courses operate in the same manner as law schools, treating every student as having the same lack of familiarity with the subject area, even though many students have developed an expertise in one or more areas of the law during law school, such as through work in a school sponsored legal clinic, summer employment as an intern at a law firm, or authoring a journal note. Even though a candidate may have substantial understanding of a particular area of the law, and even though time is at a premium, all candidates are presented with same study regimen. A bar review course should, therefore, differ from a law school course on the same subject.

Organized bar review courses originated in the 1960's and 1970's as in-person lectures accompanied by printed review materials. Some courses videotaped lectures for the benefit of candidates who missed lectures.

More recently, materials have been made available electronically, either delivered on media or over the internet. In addition, in unrelated fields, interactive multiple-choice exams have been provided over the internet, allowing applicants to answer questions on a multiple-choice exam and, upon completion, to receive an almost instantaneous score. An example is the agent's examination provided by the United States Patent and Trademark Office.

Ideally, a review course will improve an applicant's performance by providing an overview of the field tested by the exam, identifying the areas covered by the actual exam, measuring the applicant's proficiency in each area and focusing attention on areas requiring work. Determining which areas require work in order to attain a passing score is a function of the candidate's skill in each area, the historical frequency of testing of the area and the depth to which the area is tested, and predictions as to whether and how the historical statistics might change.

While applicants for admission to the bar are typically highly motivated, the volume of material tested is large and the time available for preparation is limited. Most bar review courses and hence most candidates devote about two months to preparing for the exam, which, in some states, can test on more than 20 major areas of the law, each of which can be the subject of a law school course. There is therefore a value in structure and personalization of the review process. Conventional review course materials include lectures which, by definition, are not customized, outlines and practice exams with model answers. As these materials are used by all candidates in the course, they are not optimized for each candidate and their effectiveness varies widely from candidate to candidate. Traditionally, the lectures have been presented at a scheduled time in live or videotaped format in a classroom setting through multi-hour sessions. Assessment of the candidate's understanding of the law has been primarily left to the candidate's self evaluation based on answering questions from prior bar exams or similar type questions. Thus, they are limited in their ability to identify gaps in understanding or flaws in analytical techniques.

There are currently three major national bar preparation courses. Both the PMBR Bar Review, provided by Kaplan, and the BarBri review course deliver information primarily through live or taped lectures presented in a classroom setting, although lectures are also made available online. Individual candidates are not provided with initial testing to determine what material is already known or with periodic testing immediately after lectures to determine what the candidate understands and has retained from lecture. While BarBri and Kaplan provide materials which may be used for post-lecture assessment (e.g., sample Multistate Bar Exam multiple choice questions and essay questions), they are used to evaluate progress primarily through self-grading which does not adapt the study program to the candidate's individual progress.

The Themis Bar Review delivers information primarily through online lectures. Themis provides immediate post-lecture assessment of a candidate's comprehension but does not provide pre-testing to focus a candidate on those subject areas and topics that would be of most benefit.

All three courses also provide outlines, primarily in printed book format, although more recently outlines have also been posted online, some with links between assessment questions and high-level sections of outlines.

There are conventional course-book and classroom based courses offered for preparation for other standardized tests. Examples are those offered by Kaplan and Princeton Review. There are also computer based preparation courses offered by The College Board (One-on-One with the SAT) and Princeton Review (Inside the SAT). Typically, such courses offer review materials, sample questions and practice exams with answers. These are limited to preparation for multiple-choice questions, while the bar exam includes both multiple-choice and essay questions, requiring different strategies and preparation techniques.

On the multiple choice portion of bar exams, questions typically have a stem (generally a question, although earlier bar exams used incomplete sentences) and four alternative answers (typically answers to the question or options for completing the sentence) one of which is correct. Thus, the candidate is presented with the correct answer and must merely distinguish it from the incorrect alternatives. This skill differs from the skills required to analyze a fact pattern and prepare an essay in response to a question without such guidance.

Moreover, while a series of multiple choice questions is suitable for measuring overall progress (typically by calculating the percentage of correct answers, by correlating this percentage with an expected score on the actual exam, or by identifying broad categories in which additional study is required), it is not able to produce a customized study plan corresponding to the areas where additional study is required. It is also not a good method for preparation for areas that are tested by essay or short answer questions.

### SUMMARY OF THE INVENTION

The foregoing problems are overcome, and other advantages are provided by an interactive, web based method for preparing a candidate to pass a bar exam, characterized by first assessing what the candidate knows and then directing the candidate's study towards areas likely to provide success on the bar exam, further characterized by presentation of information in “bite-sized” portions with immediate feedback through testing to ascertain comprehension and retention of those portions; further characterized by flexible scheduling which permits the candidate to select an individual start date and to work at a pace that adjusts based on the time remaining before the exam and material to be covered; and further characterized by a combination of integrated materials.

It is an object of the invention to provide an interactive, computer-based method for preparing a candidate to pass a bar exam.

It is another object of the invention to provide bar exam preparation which begins by assessing what the candidate knows and then directing the candidate's study towards areas likely to provide success on the bar exam.

It is another object of the invention to provide bar exam preparation which comprises presentation of information in “bite-sized” portions with immediate feedback through testing to ascertain comprehension and retention of those portions.

It is another object of the invention to provide bar exam preparation which permits the candidate to select an individual start date and to work at a pace that adjusts based on the time remaining before the exam and material to be covered.

It is another object of the invention to provide bar exam preparation which combines a variety of instructional materials, integrated with assessment materials to focus the candidate's attention on those instructional materials which assessment indicates are likely to improve the candidate's performance on the bar exam.

It is another objection of the invention to provide bar exam preparation which will enable an individual to pass the bar exam by:
providing a coordinated package in which lectures, handouts and candidate's notes, explanation (outline/notecards), and study devices (flowcharts, comparisons and contrasts) dovetail to produce a study plan;
assessing the candidate's existing knowledge;
initially directing the candidate's efforts to those broad subject areas and specific topics that will most benefit the candidate;
providing assessment and feedback to the candidate as to retention of the information necessary to the pass the bar exam; and
updating the study plan as a function of the candidate's progress and the time until the scheduled bar exam.

It is another object of the invention to provide pre-testing of a candidate's level of knowledge of general subject areas and specific topics and to use the results to focus efforts on areas and topics in order of their benefit to the candidate.

It is another object of the invention to provide delivery of lectures in 10-20 minute portions.

It is another object of the invention to provide immediate post-lecture testing, thereby allowing assessment of the candidate's understanding and retention of the information conveyed in the lecture and appropriate presentation of additional study materials.

It is another object of the invention to provide a system which collects and stores a current date and a date on which the candidate plans to take a bar exam, and to calculate the available time for preparation as an element in designing an individual course of preparation.

It is another object of the invention to identify areas of preferred focus, and preferably to correlate such areas with an overall preparation outline and most preferably to annotate the outline with visual or other sensory cues indicating areas of recommended focus and their relative importance.

Among the advantages of the invention are:

Delivery of material primarily through an online, electronic format rather than an in-person, classroom setting; delivery of study material on a candidate's personal schedule, at any time;

enabling the candidate to stop, start and replay lectures at will to ensure maximum understanding of information presented by lecturer;

enabling assessment of a candidate's understanding of broad subject areas (e.g., torts, contracts) and specific topics (e.g., trespass to land, statute of frauds) prior to delving into subject area or topic;

enabling assessment of a candidate's understanding of a specific topic immediately after presentation of topic, and further enabling adjusting the sequence and content of presentations in response to this assessment; and

enabling customization of a study plan based on the amount of time available prior to a scheduled bar exam.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is a flow chart of the overall method of use of the invention by a candidate preparing for a bar exam.

FIG. 2 is a more detailed flow chart of the scheduling mechanism according to the invention.

FIG. 3 is a more detailed flow chart of the initial evaluation mechanism according to the invention.

FIG. 4 is a more detailed flow chart of the instruction/evaluation mechanism according to the invention.

FIG. 5 is a more detailed flow chart of the post-instruction mechanism according to the invention.

FIG. 6 is a more detailed flow chart of the exam-type testing mechanism according to the invention.

FIG. 7 is a block diagram of the system according to the invention.

FIG. 8 is a more detailed flowchart of an alternative embodiment of the pre-instructional evaluation mechanism according to the invention.

### DESCRIPTION OF THE PREFERRED EMBODIMENT

Referring to the drawings, the invention is a novel integrated system of instruction and assessment designed to prepare an applicant for a bar exam.

The system serves two interrelated functions: a program of instruction and a program of assessment.

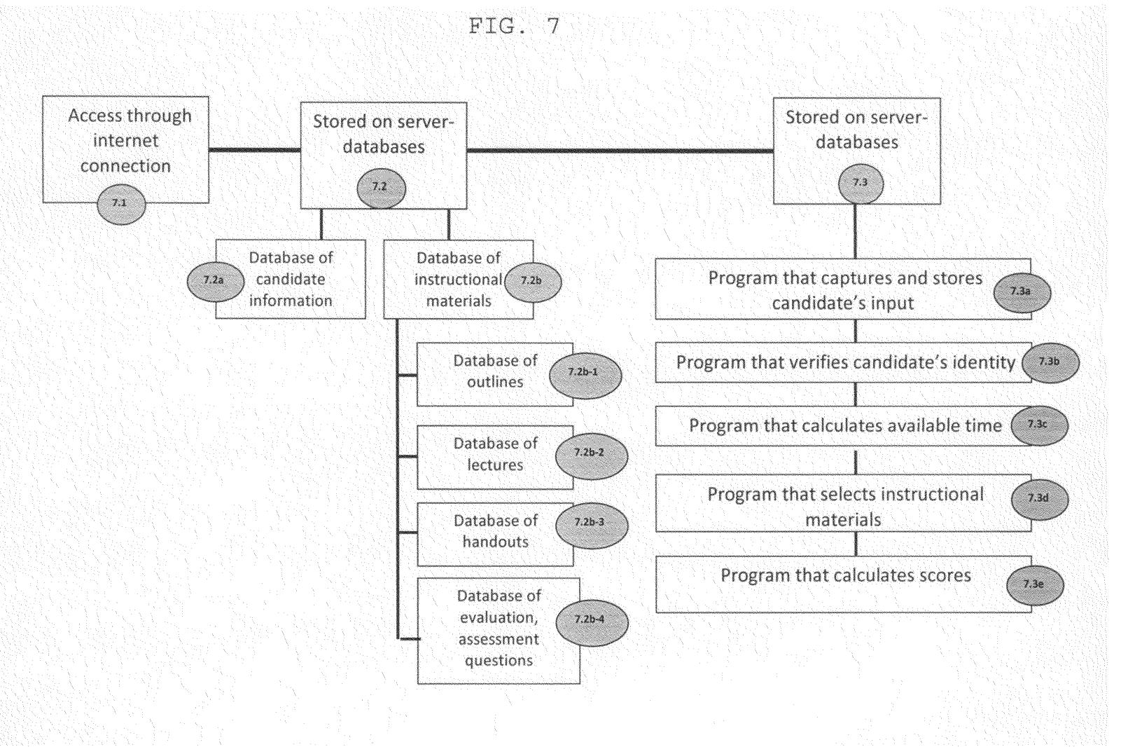

In overview, as shown in FIG. 7, the system is created by providing and storing instructional materials, keyed to subject or objective. Means for associating specific materials with subject, sequence, objective and importance are provided, as are means for interacting with the candidate to deliver instructional and assessment material and to elicit assessment responses and the planned date of the bar exam. Means for determining the current date and time are also provided.

The system comprises:

means for Internet communication between a central server and a candidate using a high-speed internet connection on a computer or other device that allows access and display of course materials (Item 7.1);

course databases stored on a central server (Item 7.2), said course databases comprising:

a database of candidate information (Item 7.2a);

and databases of instructional material and predetermined levels of mastery (Item 7.2b), comprising:

a database of outlines (Item 7.2b-1),

a database of lectures (Item 7.2b-2),

a database of handouts (Item 7.2b-3), and

a database of evaluation/assessment questions (Item 7.2b-4);

computer programs (Item 7.3), comprising:

a program that captures and stores candidate's input (Item 7.3a),

a program to verify the identity of the candidate and to confirm that the candidate is properly enrolled in the course (Item 7.3b),

a program to calculate the available time for course (Item 7.3c),

a program that selects the instructional materials to be presented to the candidate (Item 7.3d),and a program that calculates the candidate's scores and compares them to the set level of mastery (Item 7.3e).

Use of the system by a candidate begins by presenting the candidate with initial assessment questions designed to determine the candidate's initial state of preparedness, receiving the candidates responses, and using the responses to design an initial course of instruction using the stored instructional materials and an initial course of assessment using the assessment materials.

The system next begins presenting the candidate, at a time selected by the candidate, with instructional materials, preferably in segments approximately 10 to 20 minutes long. Periodically during presentation of the instruction material, preferably at intervals of 10 to 20 minutes, a question or series of questions is presented to the candidate and an additional assessment of the candidate's knowledge, skills and weaknesses is made based on the candidate's answer or answers, and the program of instruction is modified in response to this updated assessment, thereby creating a personalized program of study for the candidate.

The updated personalized program is based on the candidate's demonstrated level of knowledge and skill, but the system also stores the current date and the date on which the bar exam is scheduled to occur, thereby allowing the updated program to also be based on the pace of the candidate's progress and the time to the examination.

Based on the candidate's response to the assessment materials and the time available until the planned exam, the system updates the planned course of instruction and assessment and updates the relative importance of topics.

In a preferred embodiment, the user of the system is a candidate for admission to the bar and is provided with a master outline of the material covered by the bar exam, with topics linked to instructional material and assessment material. When a candidate has answered a predetermined percentage of the questions relating to a particular topic correctly, the topic is considered “mastered” and a visual cue, such as a green flag, is highlighted next to the related outline topic heading; when a candidate has answered below a predetermined percentage of the questions relating to a particular topic correctly, the topic is considered “in jeopardy” and a visual cue, such as a red flag, is highlighted; and when a candidate's score falls between the two predetermined percentages, the topic a visual cue, such as a yellow flag, is highlighted. These visual cues can serve as a reminder, especially useful during last-minute review, identifying areas for focus. Topics may then be selected based on level of mastery, and linked to associated instructional material.

In addition to presenting the candidate with the ability to return via a link to the relevant portion of the outline, that portion of the outline itself would be keyed, such as by highlighting or starring the material, to reflect that problem area, so that when time came to review, the candidate could see at a glance problem areas requiring attention. Moreover, if the candidate revisited that lecture and again had problems with the same question, that additional evidence of lack of understanding could be reflected in the outline, such as by increasing the intensity of the highlighting or by additional starring or by some combination thereof. In addition, the struggling candidate could be presented with additional material, such as extra examples, to help with understanding that area.

A specific embodiment is illustrated in the figures.

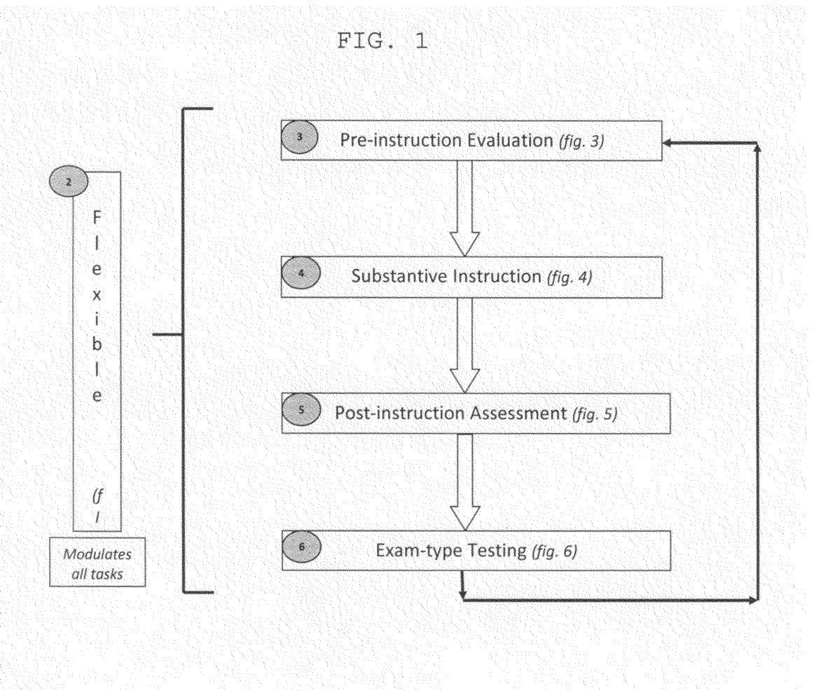

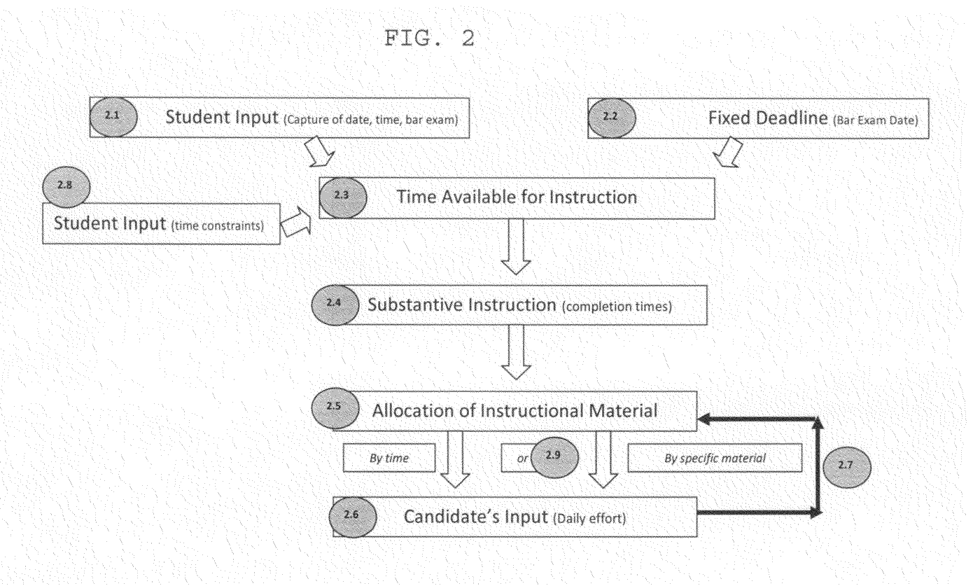

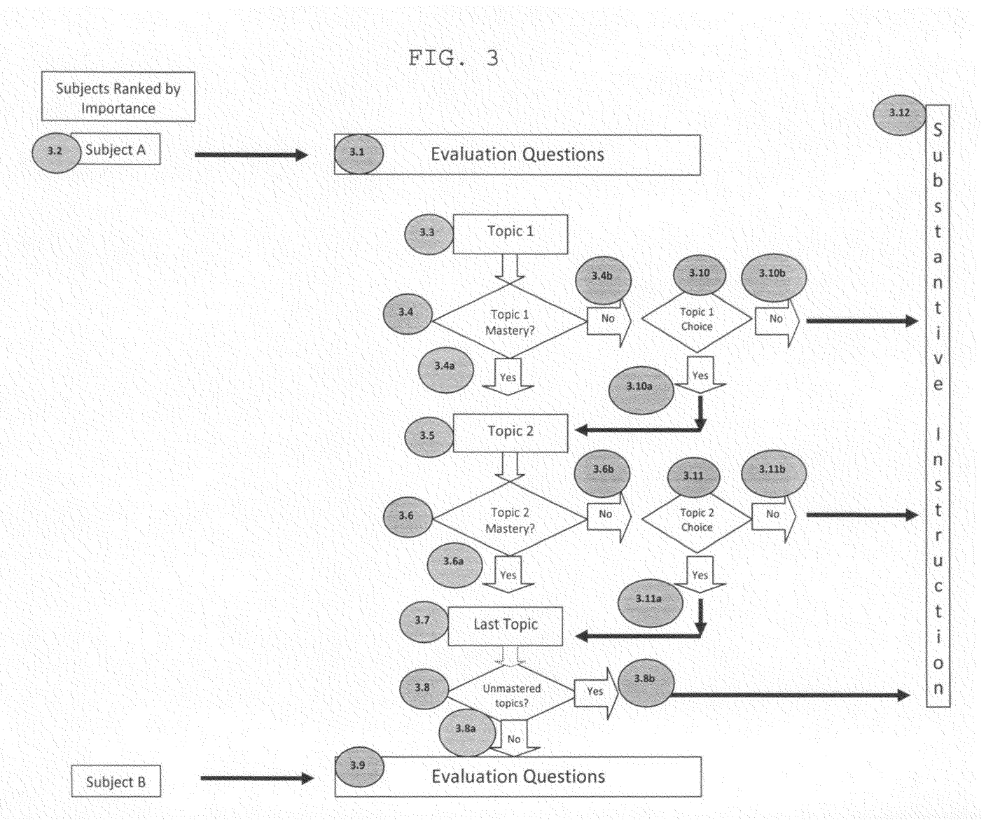

Referring to FIG. 1 for an overview of the process, in Item 1.1, a candidate ideally begins by providing the information necessary to select an initial pace of instruction: providing the current date (which may also be provided automatically) and the date on which the bar examination is scheduled (which may also be obtained from an external database of bar examination dates collected from the State Bar Examiners). More detail concerning scheduling is provided in FIG. 2. In Item 1.2, the candidate's knowledge of the law is assessed. Based on this assessment, the candidate's study is directed towards the substantive area (e.g., contracts, real property) likely to be the most “profitable” for the candidate. More detail is provided in FIG. 3. Substantive instruction lectures are presented in “bite-sized” portions of 10-20 minutes (Item 1.3). Promptly following substantive instruction, the candidate is provided with feedback through testing to ascertain comprehension and retention of this information (Item 1.4). If the candidate demonstrates an understanding of the substantive material (Item 1.5a), the candidate is provided with fact-based, exam-type questions to acclimate the candidate to the format of the bar exam (Item 1.6). If the candidate fails to demonstrate an understanding of the substantive material (Item 1.5b) or a mastery of the exam-type questions (Item 1.7b), the candidate is re-directed to substantive instruction. Where the candidate demonstrates mastery of the exam-type questions for a particular subject (Item 1.7a), the candidate is directed to the next mostly likely to be profitable substantive area (Item 1.8), and the process is repeated until all necessary substantive areas are covered, and the candidate is prepared for the bar exam.

FIG. 2 illustrates the preferred implementation of a scheduling module designed to provide a candidate with a means of allocating study time to the instructional material over the available remaining time before the exam.

The initial time available for preparation is calculated by measuring the time from the initial date to the scheduled examination date, information collected in Item 1.1 (FIG. 1). As the course progresses, the candidate will log in from time to time and the date and time of login is captured as well as bar exam that candidate will take (Item 2.1). Time available to complete course (Item 2.3) is calculated by using the captured login time/date and applicable bar exam together with beginning date and time of applicable bar exam acquired from the candidate or from state bar examiners (Item 2.2). Standard times to complete instructional material (e.g., lecture, outline) (Item 2.4) provide the basis for initial allocation of instructional material (Item 2.5). As the candidate proceeds through the course, the candidate's daily study progress is captured along with the speed at which the candidate completes instructional material (Item 2.6). Allocation of instructional material is adjusted accordingly (Item 2.7).

The candidate can adjust the calculation of available time (and thereby allocation of instructional material) by indicating time that cannot be devoted to study (e.g., special events such attending a wedding, watching a movie, taking a day off, going on a weekend trip) (Item 2.8). The candidate can select either directed study or flex study. Under directed study, the system determines the next task in the hierarchy of likely most profitable use of time and directs the student to tasks for the day (e.g., “read civil procedure outline, listen to civil procedure lecture, answer essay question number 1.”) Under flex study, the student is presented with a list of all the course's tasks and an indication of which one's have been done and may then select which task to do next.

Initial evaluation is conducted, as illustrated in FIG. 3, to ascertain the candidate's understanding of a subject area that can appear on the bar exam prior to engaging in an extensive review process. This evaluation prevents the candidate from wasting time reviewing material the candidate already understands, helps to focus the candidate's study on areas of weakness, and provides the candidate with assurance that the candidate does understand a topic and can skip review of that topic.

Initial evaluation begins by presenting the candidate with evaluation questions that test understanding of a subject area (Item 3.1). The initial subject area evaluated is the subject area that, based on information including an analysis of past bar exams and any guidelines provided by the bar examiners, will provide the candidate with the most points that can be earned on the bar exam (Item 3.2). The number of topics within a subject area and the level of questions within a topic will vary, depending on the breadth of the subject area and the complexity of the legal issues within a topic.

Within a subject area, questions focusing on a topic (Item 3.3), are presented to evaluate the student's understanding of the topic. Candidate's responses are evaluated to determine whether the candidate has mastery of the topic (Item 3.4). A candidate who has mastery of the topic (Item 3.4a) is presented with evaluation questions for the next topic within the subject area (Item 3.5). Candidate's responses are evaluated to determine whether the candidate has mastery of the topic (Item 3.6). If a candidate has mastery of the topic (Item 3.6a), this process is repeated for the remaining topics within a subject area until the candidate's knowledge of each topic within a subject area has been evaluated. After the candidate's completion of the evaluation questions for the final topic (Item 3.7), the program checks to see if there any unmastered topics (Item 3.8). If there are none (i.e., the candidate has demonstrated an understanding of each topic of the subject area) (Item 3.8a), the candidate is directed to evaluation questions for the next subject area, which is the subject area most likely to garner the candidate the second most points on the exam (Item 3.9). The process is repeated until all subject areas are covered.

Where the candidate does not achieve mastery of a topic (Items 3.4b, 3.6b), the candidate is given the choice to continue the evaluation process (Items 3.10, 3.11). The candidate can elect to continue with the evaluation process for that subject area (Items 3.10a, 311a) or go directly to the substantive instruction for that topic (Items 3.10b, 3.11b). The candidate who elects to continue the evaluation process is presented with the evaluation questions for the next topic (Items 3.5, 3.7). The candidate who elects to go directly to the substantive instruction for that topic is presented with that instruction (Item 3.12). At the conclusion of the evaluation process for a subject area, a candidate who did not demonstrated mastery with respect to one or more topics but elected to continue the evaluation process is directed to the substantive instruction for those topics over which the candidate did not demonstrate mastery (Item 3.8b).

Presentation of the instructional material in digestible form, followed by prompt assessment of a candidate's understanding of the legal principles of a subject area is critical.

In another embodiment, use of the system begins with presentation of the most productive topics (e.g., negligence-duty, constitutional law-First Amendment-Freedom of Speech-Content based restrictions, evidence-hearsay-definition). This is in contrast to a subject area approach described in the preferred embodiment, which assesses the student's abilities and presents the instructional material on the basis of overall subject areas (e.g., torts, constitutional law, evidence).

In this embodiment, with regard to either the narrower topical or broader subject area as the unit of instruction, the choice of the unit of instruction is made on not only the likely points that a candidate can earn on the bar exam but also the complexity of the instructional unit. The likely points that a candidate can earn with respect to the instructional unit is determined by allocation of points among the various units by the bar examiners (where such allocation has been made and revealed by the examiners), historical appearance of the unit on past exams, and a projection of the unit's likely appearance on the upcoming exam. The complexity of the unit is determined by the instruction necessary to present that unit to a candidate (e.g., length of written material and lectures) relative to other units. The units are ranked on the ratio of points-to-complexity. Units with the best ratio, that is, units yielding the greatest number of points when compared with the complexity of the instructional material are presented to the candidate first.

The topical approach has several benefits when compared with the subject area approach. First, rather than presenting a subject area in its entirety at one time, the topics for one subject area are likely to be spread over the available time rather than dealt with as unit. This serves the goal of keeping the overall subject area within the candidate's focus rather than dismissing it to the periphery and thereby requiring more time to bring the instructional material back into focus during review. Second, the topical approach cuts down on the length of each pre-instructional assessment of the candidate's knowledge of the law, making it more likely that the candidate will engage in such assessment. Third, the narrower scope of the topical approach permits greater accuracy in the pre-instructional assessment of the candidate's knowledge of the law. Fourth, the topical unit of instruction is an even more effective approach than the subject area unit of instruction for a candidate who runs out of time and fails to cover all areas of instruction before the exam.

It should be noted that this embodiment retains the flexibility of the subject area unit of instruction, permitting a candidate to select topics in any order that the candidate chooses. For example, a candidate who is more comfortable with approaching the material on a subject area basis, by choosing to cover all of the topics for a subject area in succession, can do so.

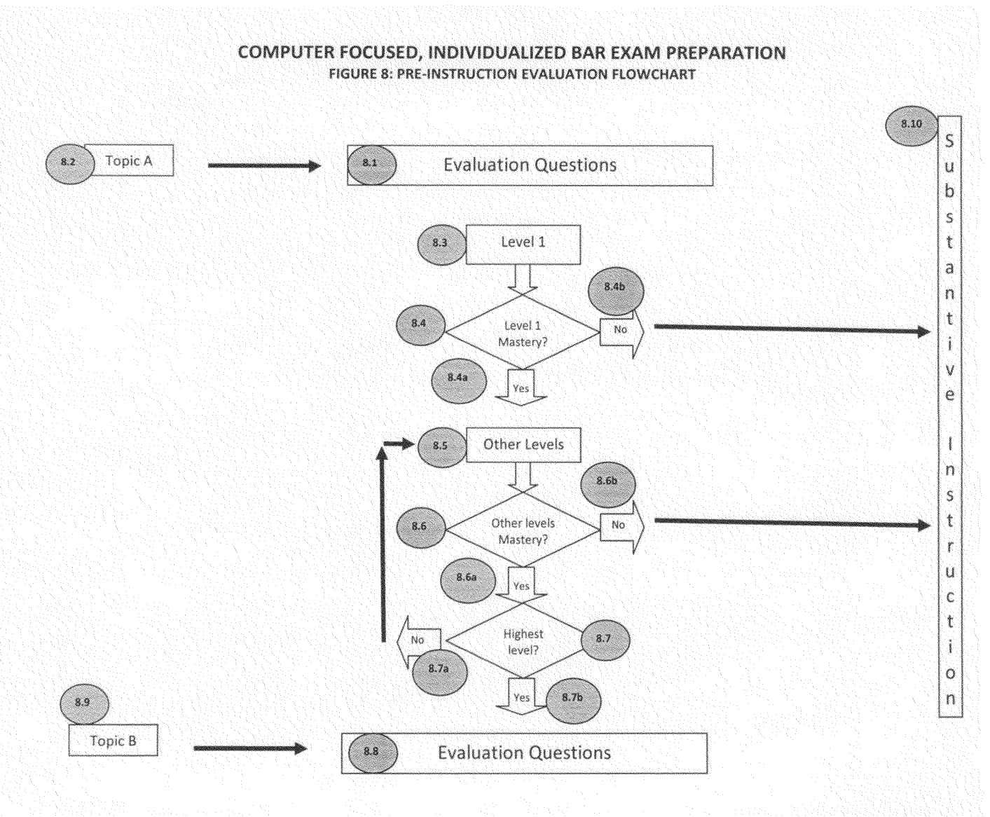

The process is similar to that of the preferred embodiment (illustrated in FIG. 3). Referring to FIG. 8, initial evaluation begins by presenting the candidate with evaluation questions that test understanding of a topic (Item 8.1). The initial topic evaluated is the topic that, based on information including an analysis of past bar exams, any guidelines provided by the bar examiners, and a projection of changes in emphasis for the upcoming bar exam, will provide the candidate with the most points that can be earned on the bar exam with the complexity of instructional materials for the topic as compared to other topics taken into account (Item 8.2).

Questions focusing on the topic (Item 8.3) are presented to evaluate the student's understanding of the basic legal principles within topic. Candidate's responses are evaluated to determine whether the candidate has mastery of those principles (Item 8.4). If candidate does not achieve mastery of a level of a topic (Items 8.4b), the candidate is direct to the substantive instruction for that topic (Items 8.10).

Candidate who has mastery of those principles (Item 8.4a) is presented with evaluation questions for the next level of difficulty within the topic where the topic is sufficiently complex (Item 8.5). Candidate's responses are evaluated to determine whether the candidate has mastery of this level of difficulty with respect to the topic (Item 8.6). If candidate does not achieve mastery of a level of a topic (Items 8.6b), candidate is direct to the substantive instruction for that topic (Items 8.10). If a candidate has mastery of this level of the topic (Item 8.6a), there is a determination whether this is the highest level of difficulty within a topic (Item 8.7). If not (Item 8.7a), this process is repeated for the next level of difficulty within a topic (Item 8.5) until the candidate's knowledge of the topic has been completely evaluated. Once a candidate has mastered the highest level of difficulty for a topic (Item 8.7b), a candidate is directed to evaluation questions for the next topic (Item 8.8), which is the topic most likely to garner the candidate the next most points on the exam considered in light of the complexity of the topic (item 8.9). Process is repeated until all topics in all subject areas are covered.

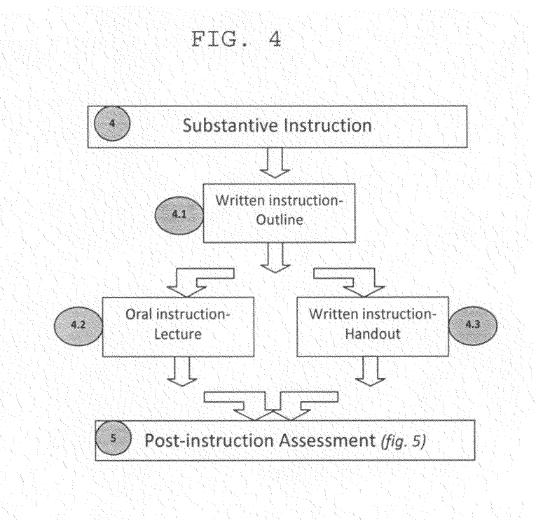

As shown in FIG. 4, the substantive instruction process is begun by providing the candidate with substantive instruction, which may be written (for example, outlines) or oral (for example, lectures), delivered in bite-sized portions that focus on a particular legal topic (Item 4.1). Bite-sized portions typically are portions designed to be presented in no more than 20 minutes, and preferably in 10 minutes or less. Promptly after a candidate is presented with an explanation of a legal topic, the candidate is provided with questions specifically designed to test the candidate's understanding and retention of the topic.

Typically the test consists of questions in a simple format, such as true/false or fill-in-the-blank, that assess the candidate understanding of the legal principles covered by the substantive instruction (Item 4.2). The candidate is then provided with the results of the assessment in a form that permits the candidate to review the legal principle and to ascertain whether mastery is achieved (Item 4.3). Where mastery is not achieved, the candidate can return to the applicable substantive instruction (Item 4.4a). Where mastery is achieved, the candidate can move on to exam-type testing (Item 4.4b) or proceed to the next topic of substantive instruction. Where mastery is achieved, the topic is flagged as “mastered”; where mastery is not achieved, the topic is flagged as “in jeopardy” and cues indicating mastery or jeopardy are associated with the topic in a database and may be displayed visually when the candidate views the outline or task list.

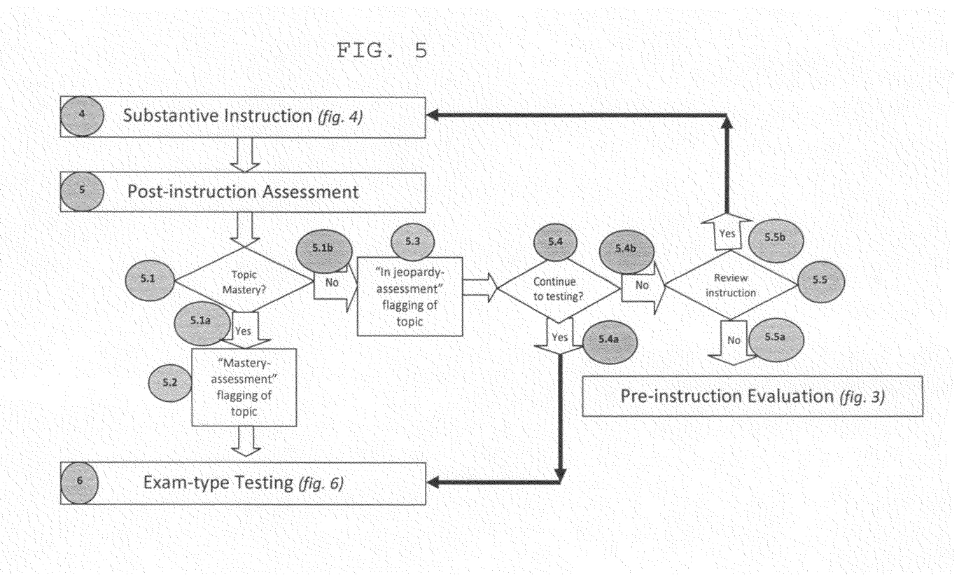

As shown in FIG. 5, promptly after a candidate is presented with an explanation of a legal topic through written and oral material (e.g., outline and lecture), the candidate is provided with questions specifically designed to test the candidate's understanding and retention of those principles within that topic. The questions take common forms, such as true-false and fill-in-the-blank, and multiple choice, that quickly ascertain whether the candidate understands those principles, which the candidate must be able to apply in order to answer the fact-based questions the candidate will face on the bar exam. The candidate is provided with the results of the assessment in a form that permits the candidate to review the legal principles and to ascertain whether mastery is achieved (Item 5.1).

Where mastery is achieved (Item 5.1a), the topic is flagged as mastered (Item 5.2) and the candidate is directed to related exam-type testing (item 6); where mastery is not achieved (Item 5.1b), the topic is flagged as “in jeopardy” (Item 5.3) and the candidate is then presented with the choice of whether to continue to the exam-type testing (Item 5.4). If the candidate elects to continue to such testing (Item 5.4a), the candidate is directed to related exam-type testing (Item 6). If the candidate elects not to continue to such testing (Item 5.4b), the candidate is presented with the choice of whether to review the substantive instruction (Item 5.5). If the candidate elects to review the substantive instruction (Item 5.5b), the candidate is direct to the substantive instruction (Item 6). If the candidate elects not to review the substantive instruction (Item 5.5a), the candidate is directed to pre-instruction evaluation of another topic (FIG. 3, Item 3).

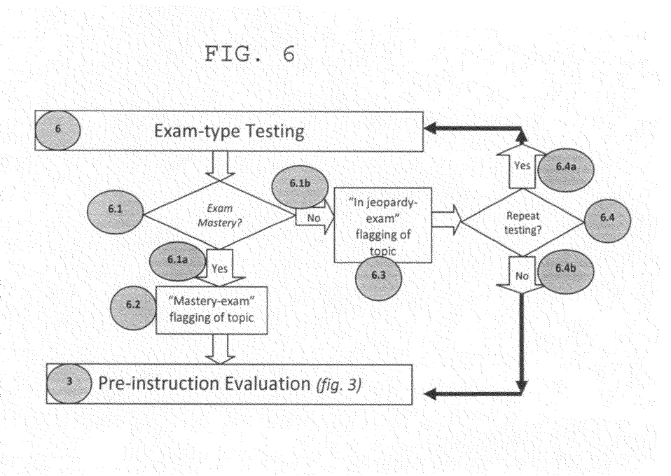

As bar exams typically include various types of fact based questions (primarily multiple choice and essay questions, although some states ask short answer format questions as well) that require application of legal principles in order to determine the correct answer, assessment of a candidate's ability to apply understanding of a subject area to exam-type fact based questions is important. Assessment through sample questions also serves the purpose of permitting a candidate to gain familiarity with the formats used on the bar exam. Ideally, this assessment takes place promptly after the candidate receives substantive instruction. As shown in FIG. 6, the process begins with presenting the candidate with questions in exam-type format (e.g., multiple choice, essay, short answer) (Item 6). The candidate provides answers to the questions and is then provided with the results of testing in a form that permits the candidate to ascertain whether mastery is achieved (item 6.1). If mastery is achieved (Item 6.1a), the topic is flagged as mastered (Item 6.2) and the candidate is directed to pre-instruction evaluation of another topic (Item 6). If mastery is not achieved (Item 6.1b), the topic is flagged as “in jeopardy” (Item 6.3) and the candidate is presented with the choice of whether to repeat the exam-type testing for that topic (Item 6.4). If the candidate elects to continue to such testing (Item 6.4a), the candidate is directed to related exam-type testing (Item 6); if the candidate elects not to repeat such testing (Item 6.4b), the candidate is directed to pre-instruction evaluation of another topic (FIG. 3). Candidate may be directed to read a specific topic within outlines on subject areas of substantive law (e.g., statute of fraud within contracts) (item 6.1) then directed to listen to lecture on that topic (item 4.2) and provided with handout based on lecture (item 4.3). After listening to lecture and completing handout, candidate's retention of the material is assessed.

While a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. For the purpose of determining inventorship, it is anticipated that claims to be made in a non-provisional patent application would include (but not be limited to) the following:

1. A computer based method for providing review in preparation for a bar exam, comprising:
providing a bank of instructional materials and a bank of comprehensive assessment materials including initial assessment materials;
providing a user interface for presenting said initial assessment materials to a user and obtaining user responses to said initial assessment materials;
presenting said initial assessment materials to a user and obtaining user responses to said initial assessment materials;
eliciting from said user the date on which the bar exam preparation must be completed;
determining the current date;
calculating the time available for review as the time between the two dates so determined;
determining from said user responses and said time available a review plan comprising a starting point within each of said banks and a path leading from the starting point to an endpoint within each of said banks;
selecting from said instructional materials a suitable module and presenting said module to said user; and
selecting from said comprehensive assessment materials a suitable assessment subset associated with the module and presenting said assessment subset to said user;
determining said user's response to said assessment subset; and
modifying said review plan in response to said user's response.

2. The process of claim 1 wherein said comprehensive assessment materials comprise a test question and associated answers, one of said associated answers constituting a correct answer; means for said user to select one of said associated answers; and means for determining whether said user has selected the correct answer.

3. The process of claim 2 wherein said assessment subset is selected in response to an evaluation of prior answers.

4. A computer based process for providing review in preparation for a bar exam, comprising:
providing a bank of instructional materials and a bank of comprehensive assessment materials including initial assessment materials;
providing a user interface for presenting said initial assessment materials to a user and obtaining user responses to said initial assessment materials;
presenting said initial assessment materials to a user and obtaining user responses to said initial assessment materials;
eliciting from said user the date on which the bar exam preparation must be completed;
determining the current date;
calculating the time available for review as the time between the two dates so determined;
determining from said user responses and said time available a review plan comprising a starting point within each of said banks and a path leading from the starting point to an endpoint within each of said banks;
selecting from said instructional materials a suitable module and presenting said module to said user;
selecting from said comprehensive assessment materials a suitable assessment subset associated with the module and presenting said assessment subset to said user;
determining said user's response to said assessment subset; and
modifying said review plan in response to said user's response.

5. The process of claim 1 wherein modules are designed to be approximately 10 to 20 minutes in time of presentation.

6. The process of claim 1 further comprising associating an assessment subset with each instructional module and delivering the associated assessment subset promptly after delivering the associated instructional module.

7. The process of claim 1, further comprising tracking said user's performance improvement.

8. The process of claim 7, further comprising adjusting said instructional plan in response to said user's performance improvement.

9. Computer readable media containing instructions for administering instructional material and comprehensive assessment material including initial assessment material related to a bar exam: computer code for accessing a bank of instructional material and a bank of assessment material;
computer code for providing a user interface for presenting said initial assessment material to a user and obtaining user responses to said initial assessment materials; computer code for presenting said initial assessment materials to a user and obtaining user responses to said initial assessment materials;
computer code for eliciting from said user the date on which the bar exam preparation must be completed; computer code for determining the current date and calculating the time available for review as the time between the two dates so determined; computer code for determining from said user responses and said time available a review plan comprising a starting point within each of said banks and a path leading from the starting point to an endpoint within each of said banks; computer code for selecting from said instructional materials a suitable module and presenting said module to said user; computer code for selecting from said comprehensive assessment materials a suitable assessment subset associated with the module and presenting said assessment subset to said user; computer code for determining said user's response to said assessment subset; and computer code for modifying said review plan in response to said user's response.

10. A machine for assisting a user to prepare for a bar exam, comprising: (a) a computing device (b) an input device for receiving input from a user and connected to said computing device; (c) an output device connected to said computing device for communication with said user; and (d) a memory storage device connected to said computing device, said memory storage device further comprising a data memory for storing a bank of instruction material and a bank of assessment material and a program memory for storing computer code as set forth in claim 9.

11. The machine of claim 10, further comprising a communication device for connecting said machine to a remote computer over the internet.

12. The machine of claim 10, further comprising:
means for Internet communication between a central server and a candidate using a high-speed internet connection on a computer or other device that allows access and display of course materials;
course databases stored on a central server, said course databases comprising:
a database of candidate information and databases of instructional material and predetermined levels of mastery, comprising:
a database of outlines,
a database of lectures,
a database of handouts, and
a database of evaluation/assessment questions;
computer programs, comprising:
a program that captures and stores candidate's input,
a program to verify the identity of the candidate and to confirm that the candidate is properly enrolled in the course,
a program to calculate the available time for course,
a program that selects the instructional materials to be presented to the candidate from the database of instructional materials, based on the candidate's performance in answering questions selected from the database of assessment questions and the predetermined levels of mastery and the available time;
and a program that calculates the candidate's scores and compares them to the set level of mastery.

13. The process of claim 6 wherein said assessment subset is formed from data associated with a topic.

14. The process of claim 6 wherein said assessment subset is formed from data associated with a subject area.

15. The machine of claim 12 wherein said database of instructional materials is categorized by topic.

16. The machine of claim 12 wherein said database of instructional materials is categorized by subject area.
